(19) United States
(12) Patent Application Publication
(10) Pub. No.: US 2012/0202170 A1
(43) Pub. Date: Aug. 9, 2012

(54) DENTAL IMPLANT ARTICLES AND METHODS

(76) Inventors: Ryan E. Johnson, St. Paul, MN (US); Naimul Karim, Maplewood, MN (US); Roger K. Dawson, Excelsior, MN (US)

(21) Appl. No.: 13/394,844

(22) PCT Filed: Oct. 21, 2010
(86) PCT No.: PCT/US10/53543

§ 371 Date: Mar. 8, 2012

Related U.S. Application Data
(60) Provisional application No. 61/255,638, filed on Oct. 28, 2009.
(60) Provisional application No. 61/372,706, filed on Aug. 11, 2010.

(51) Int. Cl. A61C 8/00; A61C 13/20

(52) U.S. Cl. 433/173; 264/17

(57) ABSTRACT

Presently described are dental implant articles, including kits, methods of making dental implant articles and methods of use. The dental implant articles (200) described herein comprise preformed dental implant abutment (210) integrated therein. The preformed dental implant abutment comprises a subgingival implant anchor-receiving end and an opposing end wherein the opposing end is permanently bonded within a sufficiently malleable dental material, which preferably comprises tooth-shaped gingival exterior surfaces (201).

### BACKGROUND

As described for example in the Background of US 2007/0031793, a widely-used form of dental implant fixture, includes a generally cylindrical body which is implanted in a cylindrical bore made in the patient's jawbone (i.e., an endosseous implant) at the site of a edentulous ridge or tooth extraction socket, and having an internally-threaded cylindrical socket in which to fasten components used for attaching a permanent restoration to the implant fixture once the jawbone and gumline are healed. Prior to healing, the abutment is releasably fastened into cylindrical body by screwing threads into the implant socket. Once the abutment is releasably secured in place, the appropriately sized pre-fabricated temporary attachment is placed over abutment such that the void is mated with abutment properly adjusted (interproximally and occlusally), and the crown is secured in place using a suitable temporary dental fixative. The temporary abutment and temporary attachment may generally be left in place for period of time, e.g., 2 months, 3 months, 6 months, etc. sufficient to allow for healing of the patient's jawbone and gumline. Once healed, the temporary attachment may be removed, and a permanent restoration put in place on the implant fixture, as known in the art.

### BRIEF DESCRIPTION OF THE DRAWINGS

FIG. 1 is a perspective view of an embodied preformed dental implant article affixed to an implant anchor and a cross-sectional view of the adjacent dental tissue.

FIG. 2 is a perspective exploded view of another embodied dental implant article and implant anchor.

FIG. 3 is a photograph of a dental implant abutment.

### SUMMARY

Even when the implant is covered with a temporary attachment such as a provisional crown or healing cap, the gingival tissue around the extracted tooth typically retracts losing its natural emergence profile, leading to poor esthetics. This gingival tissue retraction is surmised to be caused by the provisional crown or temporary attachment not being properly sized and/or shaped relative to the extracted tooth and subsequent permanent restoration. Often there is a locational or angular misplacement of the implant relative to the neighboring dentition. Such misplacement can be unintentional or intentional, dictated by the primary consideration of available bone structure and/or function of the implant, rather than esthetical consideration.

Accordingly, industry would find advantage in preformed dental implant articles that can be customized in shape in order to manage the shape of the healing (e.g. gingival and/or internal) dental tissue.

### DETAILED DESCRIPTION

Presently described are dental implant articles, including kits, methods of making dental implant articles and methods of use. The dental implant articles described herein comprise preformed dental implant abutment integrated therein. The preformed dental implant abutment comprises a subgingival implant anchor-receiving end and an opposing end wherein the opposing end is permanently bonded within a sufficiently malleable dental material.

In some embodiments, the dental implant article may be described as preassembled dental implant articles. In such embodiment, a preformed dental implant abutment is permanently bonded to (a piece of) sufficiently malleable material prior to use (e.g. as packaged) or as received by the dental practitioner.

In other embodiment, a dental implant article is described comprising a dental implant abutment comprising a subgingival implant anchor-receiving end and an opposing end wherein the opposing end is embedded within a sufficiently malleable material having tooth-shaped gingival and subgingival exterior surfaces at an interface that is free of cement and adhesive.

The dental implant abutment comprises a subgingival implant anchor-receiving end and an opposing end wherein the opposing end is permanently bonded (e.g. embedded) within a (piece of) sufficiently malleable dental material. The opposing end may be permanently bonded by mechanical means, chemical, means, or a combination thereof. The sufficiently malleable dental material can be customized in shape and hardened by curing. The dental implant abutment generally comprises a different material than the implant abutment.

In preferred embodiments, the dental implant article comprises substantially tooth-shaped gingival and subgingival exterior surfaces, i.e. at least where the dental implant article contacts the gingival tissue and internal (e.g. connective) tissue beneath the gingival tissue for the purpose of managing the shape of the healing tissue.

In some embodiments, the dental implant article lacks tooth-shaped supragingival exterior (i.e. external) surfaces and may be characterized as a healing cap. In other embodiments, the dental implant article comprises supragingival exterior (i.e. external) surfaces and may be characterized as a (e.g. temporary or provisional) crown.

The dental implant article is advantageous in that the use thereof is amenable to a more efficient process by eliminating the step of the dental practitioner or dental lab cementing the (e.g. crown) restoration or healing cap onto the implant abutment. Further, since the implant abutment is embedded during manufacture, the interface between the implant abutment and sufficiently malleable material can be free of adhesive and cement.

The presence of adhesives and cements can typically be distinguished from a restoration dental material such as a sufficiently malleable material by qualitative analysis of the components and/or quantitative analysis of the inorganic filler content. In some embodiments, the interface comprises different components typically derived from the use of different polymerizable monomers or oligomers. When the adhesive or cement present at the interface comprises substantially the same polymerizable material, the adhesive or cement can typically be distinguished by its inorganic filler content. Whereas, the sufficiently malleable material typically comprises a filler concentration of at least 50 wt-%, or 60 wt-%, or 70 wt-%; adhesives and cements normally have a filler content of no greater than about 30 wt-%.

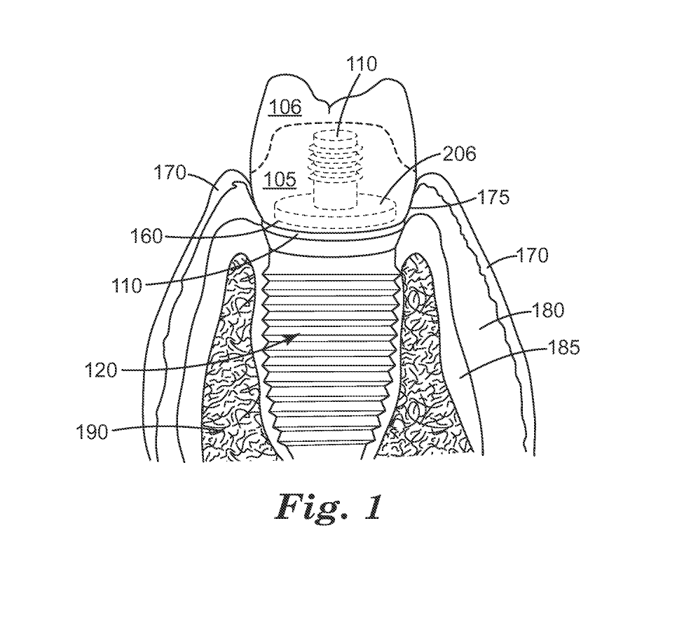

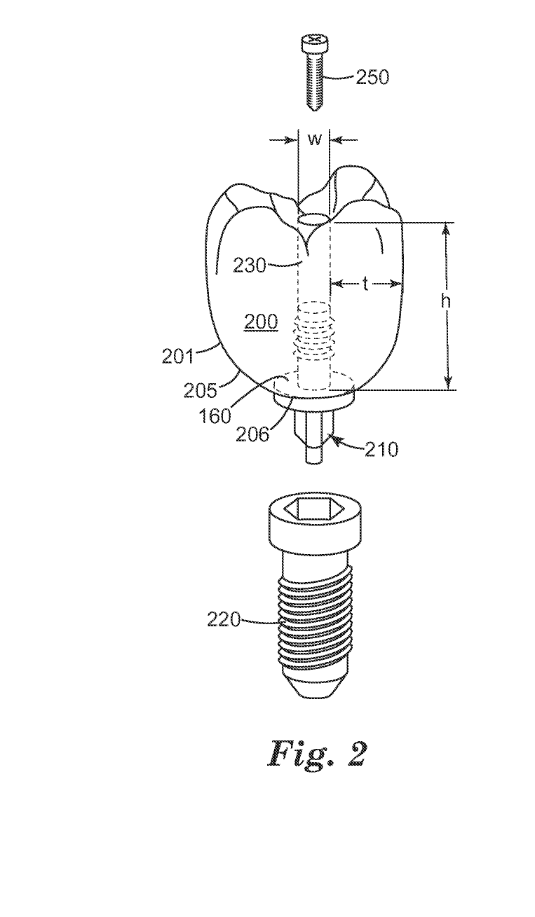

Various dental implant systems, as known in the art, may be used in combination with the methods and dental implant articles described herein. With reference to FIGS. 1-2, dental implant systems generally include a (e.g. cylindrical) anchor 120 and 220 that is implanted in the patient's jawbone. The dental implant system also includes a temporary or permanent abutment 110 and 210 that mates with the anchor and extends at least slightly above the gum line.

The abutment may take the form of an elongated tubular body which has a base portion adapted at a first end of the body to mate with the gingival aspect of the implant anchor, and a solid or thin-walled tubular portion extending to the other end of the body supragingivally from the base portion when the base portion is so mated.

Various suitable implant abutments, as known in the art, may be used in connection with the methods and dental implant articles described herein, such as commercially available from Straumanns, 31, Astra tech, Zimmer, and Nobel.

Abutments may be made with a variety of materials including metals, (e.g. palladium-silver alloy, stainless steel, aluminum, titanium, titanium-alloy gold etc.), plastic materials (e.g. acrylics) including plastics that further comprise an inorganic filler; and ceramic materials such as those comprising zirconia and aluminum oxide, etc. Composite abutments can be made using a mixture of these materials. For example, a filled plastic is a composite material.

In some embodiments, the implant abutment is a preformed (e.g. one piece) abutment having a (e.g. hex-shaped) implant (e.g. anchor) receiving end and an opposing end. Alternatively, the implant abutment may be a (e.g. metal/ceramic) hybrid abutment. For example, the implant abutment may comprise a preformed metal abutment that is an abutment interface having an implant-receiving end for attachment to a tooth implant (e.g. anchor) and an opposing end comprising a ceramic abutment “top” as can be prepared from Lava™ Zirconia available from 3M ESPE. Unless specifically stated otherwise, the term “implant abutment” as used herein also encompasses implant abutment interfaces having an abutment as well.

Hence the implant abutment may be a metal abutment, a ceramic abutment, a plastic abutment, a composite abutment, or a hybrid thereof.

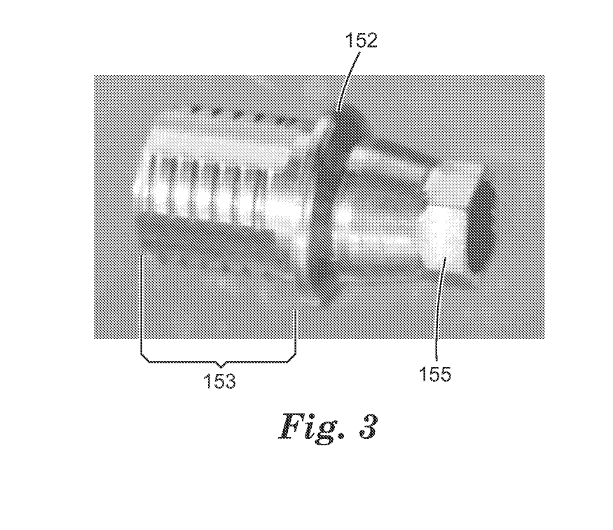

With reference to FIG. 3, a perspective view of an illustrative preformed implant abutment (e.g. interface), the implant abutment may take the form of an elongated tubular body generally comprising a (e.g. hex shaped) base end 155 that is designed to mate with the implant (e.g. anchor) and an opposing end 153. The opposing end typically includes a subgingival portion, a gingival portion, as well as a supragingal portion. The opposing end is embedded within the sufficiently malleable material.

The implant abutment is typically provided within the sufficiently malleable material such that the platform 160 and opposing end above such platform are contacting the sufficiently malleable material. The subgingival implant-receiving end of the implant is typically exposed. The subgingival implant-receiving end typically protrudes from the outer surface of the piece of sufficiently malleable material. Abutments that include a platform are commercially available from Nobel Biocare under the trade designation “Easy Abutment”.

Alternatively, the abutment may lack a platform. In such embodiment, the base of the sufficiently malleable portion may rest directly on the implant anchor. Exemplary abutments that lack a platform are commercially available from Straumann ITI.

Abutments comprising external threads to mate with internal threads of the implant anchor have been described in the art, such as depicted in US 2010/0151423. Such design is suitable for embodiments wherein a dental article (such as a healing cap or temporary crown) are affixed to the implant abutment after the implant abutment has been mechanically attached to the implant anchor, such as described in PCT/US2010/022961. However, due to the fact that the entire abutment needs to be rotated in order to engage the threads of the abutment with the anchor, it is appreciated that the supragingival portion may contact neighboring teeth during such rotation. Further misalignments with the oral cavity are likely to occur, particularly when the material is cured prior to the dental implant article being mechanically attached to the underlying anchor.

In one favored embodiment, (such as depicted in FIG. 2) the abutment comprises a shoulder (not shown) within the cavity for cooperation with a screw 250 to fasten the abutment to the implant anchor. Since the abutment is mechanically attached to the underlying implant anchor with a screw, the entire abutment need not be rotated in order to attach the abutment to the implant anchor.

For embodiments wherein the implant abutment comprises a shoulder within the cavity for cooperation with a screw 250 to fasten the abutment to the implant anchor, the (e.g. self-supporting) piece of sufficiently malleable material further comprises a vertical bore, as depicted in FIG. 2 for providing access to an internal bore of the implant abutment. As depicted, the vertical bore extends the entire height of the sufficiently malleable material (top) portion. Although such vertical bore 230 may be created after fabrication, such as by drilling, it is preferable to provide a (e.g. preassembled) dental implant article wherein the internal bore is already present. In one embodiment, such internal bore is created during the molding of the piece of sufficiently malleable material by including such cylindrical-shaped structure within the mold cavity design. Since this internal bore is filled with a material, after attaching the dental implant article to the implant anchor, such internal bore need not be precisely formed. The internal bore may be filled with additional sufficiently malleable material, and more typically a different (e.g. low viscosity) curable dental restoration material such as commercially available from 3M ESPE under the trade designation “Filtek Supreme Plus Flowable Restorative”. Vertical bores (also referred to as an interior cavity) 230, that are substantially conical or cylindrical in shape can accommodate a wide variety of implant designs.

With reference to FIG. 2, the width (“w”) of the interior cavity (i.e. vertical bore) at the base of the sufficiently malleable portion of the dental implant article typically ranges from about 2 mm to about 6 mm, (e.g., 2.5 mm, 3.3 mm, 3.5 mm, 4.0 mm, 4.1 mm, 4.3 mm, 4.8 mm, 5.0 mm, 6.0 mm etc.) Suitable heights (“h”) for such cavity may be configured to match known implant abutment heights. Typically, the height is at least about 10 mm and no greater than about 20 mm. Abutment interfaces are typically shorter, having a height of at least about 3 mm.

In one embodiment, the preformed dental implant article comprises an interior cavity (i.e. vertical bore) and the thickness (“t”) of the dental implant article between the cavity and apical (i.e. highest point relative to the base) gingival exterior surface 201 is preferably at least 1 mm (except in the case of a lower incisor or lower lateral). When the sufficiently malleable portion of the dental implant article comprises a convex gingival surface, the apical gingival exterior surface may be characterized by the onset of curvature. In some embodiments, the thickness (“t”) may be at least 1.1, 1.2, 1.3, or 1.4 mm. In the case of premolars, the thickness is typically at least 1.50 mm. In some embodiments, the thickness (“t”) may be at least 1.6, 1.7, 1.8, or 1.9 mm. For molars, this thickness is typically at least 2, 2.5, or 3 mm.

In some embodiments, the dental implant article comprises tooth-shaped supragingival exterior surfaces. When the dental implant article is substantially tooth-shaped above the gum line, the dental implant article may serve as a permanent rather than temporary restoration.

The exterior geometry of implant abutments have previously been designed in consideration of the fabrication of subsequently seated (e.g. crown) restorations. Hence, for embodiments wherein currently commercially available implant abutments are embedded into the sufficiently malleable material, the supragingival exterior surfaces of the abutment are generally free of any structural features that would detract from the fit between the exterior surface of the abutment and the restorative. Hence, the supragingival exterior surfaces of (commercially available) abutments are generally free of undercuts, as well as deep (e.g. horizontal) grooves or protrusions (e.g. having a difference in depth of about 0.1 mm or greater).

However, since it is presently described to embed the supragingival end of the implant abutment within the sufficiently malleable material prior to use, the presence of undercuts and deep grooves can be present and may be advantageous for the purpose of mechanically bonding the implant abutment within the surrounding sufficiently malleable material.

As depicted in FIG. 3, the supragingival end of the implant abutment preferably comprise one or more (anti-pull) retention features, such as (e.g. shallow) grooves that hinder removal of the abutment from the sufficiently malleable material portion. In some embodiments, such (anti-pull) retention features have a depth no greater than about 0.1 mm. Other (anti-pull) retention features include for example shallow horizontal flat(s), horizontal groove(s), or horizontal protrusion(s). Alternatively or in addition to mechanical retention features, the supragingival end of commercially available implant abutment can be mechanically or chemically surface modified to improve adhesive.

Such (e.g. shallow) mechanical features and/or other surface modification can increase the surface area and mechanically interlock with the surrounding sufficiently malleable material, particularly upon curing the sufficiently malleable material.

In some embodiments, the (supragingival) opposing end is roughened for example for sandblasting. The surface roughness (Ra) of the uncoated abutment may be about 1 for a metal abutment that has not been subjected to surface roughening. A sandblasted metal abutment may have a surface roughness (Ra) of about 2 to 3. As the roughness increases, the bond strength between the abutment and sufficiently malleable material or other (e.g. dental restoration) material at the abutment interface can also increase.

In some embodiments, the (supragingival) opposing end of the implant abutment comprises a coating that increases the surface roughness and/or improves the adhesion with the sufficiently malleable material (without substantially changing the surface roughness). In one embodiment, such as when the dental implant abutment is a metal implant abutment or made from some other material that is not tooth-colored, it may be advantageous to coat at least the supragingival surfaces with an opaque (e.g. tooth-colored) coating to mask the appearance of the preformed metal abutment, thereby improving the aesthetic appearance of the dental (e.g. healing cap or crown) restoration, such as described in Pending U.S. Application Ser. No. 61/242,546, filed Sep. 15, 2009. Such coatings generally comprise a polymeric binder and at least one opaque filler and/or pigment. The inclusion of the coating can alter the reflection properties of a metal abutment. The coating can increase the total reflection of the metal abutment such that the total reflection is at least 25%, 30%, 40%, 45%, 50%, or 55% at wavelengths of visible light. Such coating can also increase the roughness of the coated implant abutment. For example, the coated surfaces of the abutment may have a surface roughness, Ra, of at least 3 and more preferably at least 4, 5, or 6. In some embodiments, the surface roughness is at least 10, 15, or 20.

In another embodiment, the opposing (supragingival) end of the implant abutment comprises a coating of a dental restoration. One suitable dental restoration material is the previously described “Filtek Supreme Plus Flowable Restorative”.

In some embodiments, the coating is applied to the implant abutment and cured prior to embedding or otherwise permanently bonding the opposing end of the implant abutment within the sufficiently malleable material. In other embodiments, the packaged dental implant article comprises an uncured or only partially cured coating between the abutment interface and the sufficiently malleable material. The coating is cured concurrently with the curing of the sufficiently malleable material after shaping of the sufficiently malleable material.

Regardless of design, the implant abutment generally comprises a gingival (e.g. platform) section between the subgingival and supragingival ends of the implant abutment. Further, the supragingival end protrudes into the sufficiently malleable material, having a contacting surface area greater than a cross-section (area) of implant abutment at the gingival section. The increase in surface area can vary depending on the type of dental implant article. The increase in surface are can be at least 10%, 20%, 30%, 40%, 50%, or greater, particularly when the dental restoration is a crown.

Implant abutments typically comprise one or more anti-rotation features as known in the art. For example, the subgingival end of the abutment that mates with the implant (e.g. anchor) are typically hexagonal 155 in shape that can prevent the rotation of the implant abutment within the bore of the implant (e.g. anchor). The (supragingival) opposing end of the implant abutment may also comprise one or more anti-rotation features that can prevent rotation of the implant abutment within the sufficiently malleable material. The (supragingival) opposing end may include for example vertical flat(s), vertical groove(s), or vertical protrusion(s).

With reference to FIG. 2, the dental implant article 200 preferably comprises substantially tooth-shaped gingival exterior surfaces 201. “Gingival exterior surface” refers to the exterior surfaces that will come in contact with the gingival tissue. The dental implant article 200 also preferably comprises substantially tooth-shaped subgingival exterior surfaces 205. “Subgingival exterior surface” refers to the exterior surfaces between the base and gingival exterior surfaces that will come in contact with internal (e.g. connective) tissue beneath the gum line.

The sufficiently malleable portion of the preformed dental implant article preferably comprises a convex gingival exterior surface 201. Particularly for molar implants, the sufficiently malleable portion of the dental implant article further comprises a convex subgingival exterior surface 205. Hence, the exterior surface may be continuously convex from the gingival exterior surface to the substantially planar base exterior surface that contacts the implant abutment (platform 160 of FIG. 1). Although the radius of curvature of this convex surface can vary, the radius of curvature is typically at least 2 mm and no greater than 10 mm. Alternatively, such as in the case of incisors the subgingival exterior surfaces of the sufficiently malleable portion of the dental implant article may comprise a slight concavity (not shown).

In some embodiments, such as depicted by the FIG. 2, the dental implant article comprises substantially tooth-shaped exterior surfaces both below and above the gum line. For example, the shape may take the form of a natural maxillary or mandibular tooth, including anterior crowns (i.e. central incisor, lateral incisor, canine), premolar, or molar tooth. This can be accomplished by preforming the dental implant article such that the exterior surfaces comprise both subgingival and supragingival tooth-shaped exterior surfaces.

In other embodiments, such as depicted by the dental implant article 105 outlined by the dashed lines of FIG. 1, the (e.g. temporary) dental article may be predominantly a healing cap. In such embodiment, a preformed dental implant article is described wherein the supragingival exterior surfaces substantially lack a tooth-shaped structure and at least the exterior surfaces (e.g. that contact the healing gum tissue) comprise a sufficiently malleable such that it can be customized in shape and hardened. A crown 106 having substantially tooth-shaped supragingival exterior surfaces can be affixed to the dental implant article 105 with a dental cement as known in the art. Typically, the cavity 230 of the dental crown article is partially filled with a dental cement and then placed over the healing cap such that the base of the crown contacts the abutment platform 160. A temporary dental cement is typically used for embodiments wherein the crown is affixed temporarily. Suitable temporary cements are commercially available such as available from 3M ESPE under the trade designation “RelyX Temp NE Temporary Cement”. A permanent dental cement, such as commercially available from 3M ESPE under the trade designation “RelyX Unicem Self Adhesive Universal Resin Cement”, is employed for embodiments wherein the crown is a permanent dental article and functions as a permanent restoration.

In other embodiments, kits are described comprising a single dental implant article or a plurality of dental implant articles optionally in combination with other dental articles employed during a tooth implant procedure.

The dental implant articles may correspond in size and shape to natural teeth selected from the group consisting of maxillary and mandibular central incisors, lateral incisors, canines, premolars, and molar teeth. The kit may comprise dental implant articles of more than one shade of tooth color, in order to select a dental implant article that closely matches the patent's natural teeth. The kit may further include or be combined with other article employed during a tooth implant procedure such as an implant anchor.

The dental implant articles described herein can be used in method of treatment, such as described in PCT/US2010/022961; incorporated herein by reference. In one embodiment, a method of affixing a dental implant article to an implant anchor is described. The method generally comprises providing a preformed (e.g. temporary or permanent) dental implant article and affixing the dental implant article to an implant anchor. In one embodiment, the method comprises providing a preformed dental implant article comprised of a sufficiently malleable material such that at least the exterior portion can be customized in shape; shaping at least a portion of the dental article that contacts gingival tissue or internal tissue beneath the gingival tissue; affixing the dental implant article to an implant anchor such that the sufficiently malleable portion contacts the gingival tissue and internal tissue; and hardening at least the sufficiently malleable portion of the dental article. The sufficiently material may be hardened by photocuring.

Typically, the dental implant article is attached after extraction of a tooth and prior to healing of the gingival and internal tissue.

As known in the art, the gingival sulcus is bound by the enamel of the crown of a tooth and the sulcular gingival epithelium. The junctional epithelium attaches to the surface of the tooth with hemideosomes and lies immediately apical to the sulcular epithelium. The sulcular epithelium lines the gingival sulcus from the base to the free gingival margin, wherein it interfaces with the epithelium of the oral cavity. Damage to the junctional epithelium can result in this tissue having an irregular rather than smooth texture thereby forming a “pocket”, a primary symptom of gum disease.

Accordingly, to avoid damaging the junctional epithelium, restorative crowns are generally affixed to a natural tooth surface or healed implant abutment such that the exterior (i.e. external) surfaces of the crown contact the sulcular gingival tissue, but not the junctional epithelium.

FIG. 1 depicts a perspective view of an embodied preformed dental implant article affixed to an implant abutment and a cross-sectional view of the adjacent dental tissue. FIG. 1 is representative of affixing a preformed dental implant article having an embedded abutment (e.g. immediately) after extraction of a tooth and prior to healing of the gingival and internal tissue. The method described herein comprises affixing a preformed dental implant article 105 to an implant anchor 120 such that exterior surfaces of the dental implant article contact sulcular gingival epithelium tissue 170 and internal tissue beneath (e.g. covered or concealed by) the gingival tissue. The internal tissue contacting the exterior surface of the dental implant article may include the junctional epithelium 175. Typically, however, the junctional epithelium may also be removed during the tooth extraction. More typically, the sufficiently malleable portion of the dental implant article is in contact with connective tissue 180 which is disposed between the gingival tissue 170 and jaw bone tissue 190. The internal tissue(s) in contact with the sufficiently malleable portion are typically above the cortical plate 185. It is appreciated that the specific type of tissue in contact with the exterior surfaces of the dental implant article may change as a result of the healing process. Nonetheless, the dental implant article is in contact with internal dental tissue beneath the gingival tissue.

The method further comprises shaping at least a portion of the sufficiently malleable material that contacts gingival tissue 170 or internal (e.g. connective 180) tissue beneath the gingival tissue and hardening at least the sufficiently malleable material. The method may also entail curing a second (i.e. different) curable dental material that may be present. For example, in some embodiments the (e.g. metal) dental implant abutment or interface is coated with a curable dental restoration material for the purpose of improving adhesion with the (e.g. metal) dental implant abutment or interface. This second curable dental restoration material is concurrently cured along with the sufficiently malleable material. By use of a dental implant article comprised of a sufficiently malleable material, the dental implant article can be subsequently customized in shape. Typically, such shaping occurs under a moderate force (i.e., a force that ranges from light finger pressure to that applied with manual operation of a small hand tool, such as a dental composite instrument). The preformed shape in combination with the customization thereof can manage the shape of at least the gingival tissue during the healing of the implant. When the preformed dental implant article is comprised of a sufficiently malleable material, as described herein, the dental implant article can be optimized in shape such that the optimized shape obstructs the recession of the gingival tissue and guides the gingival tissue to heal in a shape substantially the same as the natural emergence profile. Doing so can eliminate the need for tissue adjustment via electro surgery or scalpel as well as prevent blanching and impingement of soft tissue at the final restoration stage. At the time of a tooth extraction, the sufficiently malleable material can be optimized in shape to conform to the shape of the resulting socket. However, when a dental implant procedure to replace a tooth that has been missing for sufficient time that the gum tissue has already recessed or begun to recess, the sufficiently malleable material can be used in combination with surgical procedures to recreate the natural emergence profile of the surrounding gum tissue.

The shaping of the sufficiently malleable portion of the dental implant article typically occurs prior to affixing the dental implant article to the implant anchor. However, the dental implant article can alternatively or additionally be shaped after affixing the dental implant article to the implant anchor, yet prior to hardening (e.g. by photocuring). Particularly for this later embodiment, the dental implant article preferably comprises a cylindrical or conical shaped cavity to provide access for a screw for attaching the dental implant article to the underlying implant anchor with a screw, as previously described.

After the dental implant article has been affixed (i.e. mechanically attached to the anchor), shaped, and hardened, the method further comprises allowing the gingival tissues to heal. Once the anchor 120 of the implant has osseointegrated into the jaw bone, which typically takes 2 to 6 months, the temporary dental implant article is typically replaced with a permanent restoration such as a permanent crown or bridge, as known in the art. Alternatively, the method described herein can also be employed with a two-step implant method. As known in the art, the two-step method entails suturing the skin over the head of the implant in the area of the implant wound after surgery to allow for healing of the patient's jawbone and gumline. Once the implant has osteointegrated into the jaw bone, the healed dental tissue above the tooth implant is surgically removed in order to expose the head of the implant for receipt of a temporary or permanent crown. Accordingly, when the two-step method is employed, the method further comprises removing (healed) dental tissue above the tooth implant abutment or anchor such that gingival tissue, internal tissue, and the tooth implant anchor are exposed prior to affixing the dental implant article.

When the dental implant article is a temporary article, such as a healing cap, the method typically further comprises allowing the gingival and internal tissue to heal and replacing the dental implant article with a permanent restoration.

In another embodiment, a method of providing a permanent restoration for a tooth implant is described. The method comprises removing a temporary dental implant article from an implant anchor, wherein the temporary dental implant article contacts the internal tissue beneath the gingival tissue and is formed from a hardened photocured material; and affixing a permanent restoration to the implant anchor.

Alternatively, the method may further comprise affixing a restoration comprising substantially tooth-shaped supragingival exterior surfaces to the dental (e.g. healing cap) article lacking tooth-shaped supragingival exterior surfaces.

The preformed (e.g. temporary) dental implant articles are prepared from a hardenable material that can be customized in shape to specifically mate to the gingival and/or internal tissue beneath the gingival tissue. The preformed dental implant articles (of a first shape) are preferably prepared from a hardenable self-supporting resin system with sufficient malleability to be subsequently customized into a second shape.

Herein, the “resin system” can include one or more resins, each of which can include one or more monomers, oligomers, and/or polymerizable polymers.

The term “self-supporting” means that the composition is dimensionally stable and will maintain its shape (e.g., preformed shape of a cap) without significant deformation at room temperature (i.e., about 20° C. to about 25° C.) for at least about two weeks when free-standing (i.e., without the support of packaging or a container). Preferably, the compositions are dimensionally stable at room temperature for at least about one month, and more preferably, for at least about six months. Preferably, the compositions are dimensionally stable at temperatures above room temperature, more preferably up to about 40° C., even more preferably up to about 50° C., and even more preferably up to about 60° C. This definition applies in the absence of conditions that activate the initiator system and in the absence of an external force other than gravity.

The term “sufficient malleability” means that the material or self-supporting structure formed from the material is capable of being custom shaped and fitted, for example, to a patient's mouth, under a moderate force (i.e., a force that ranges from light finger pressure to that applied with manual operation of a small hand tool, such as a dental composite instrument). In some embodiments, the material or self-supporting preformed structure has sufficient malleability to be reformed into a second shape at temperature of 40° C. of less. In some preferred embodiments, the hardenable composition exhibits “sufficient malleability” at a temperature of about 15° C. to 38° C., a temperature of about 20° C. to 38° C., or at room temperature.

In many embodiments, the hardenable compositions of the preformed dental implant articles described herein are “irreversibly hardenable” which, as used herein, means that after hardening such that the composition loses its malleability it cannot be converted back into a malleable form without destroying the external shape of the dental article. Examples of some potentially suitable hardenable compositions that may be used to construct the preformed dental implant article described herein with sufficient malleability may include, e.g., hardenable organic compositions (filled or unfilled), polymerizable dental waxes, hardenable dental compositions having a wax-like or clay-like consistency in the unhardened state, etc. In some embodiments, the preformed dental articles are constructed of hardenable compositions that consist essentially of non-metallic materials.

Examples of hardenable organic compositions (filled or unfilled) include various dental restoration materials including for example packable composites commercially available under the trade designations “Solitaire” from Heraeus Kulzer (Hanau, Germany); “ALERT” from Jeneric-Pentron (Wallingford, Conn.); “SureFil” from Dentsply/Caulk (York, Pa.); “Prodigy Condensable” from Kerr (Orange, Calif.); posterior composite material commercially available under the trade designations “Filtek P60 Posterior Restorative” from 3M ESPE; and universal composites commercially available under the trade designations “Venus diamond” from Heraeus Kulzer and “Filtek Supreme Ultra” from 3M ESPE. In some embodiments, such hardenable organic compositions may be self-supporting. In other embodiments, such hardenable organic compositions are not self-supporting.

Suitable hardenable compositions that may be used to manufacture the preformed dental implant articles are described in U.S. Pat. No. 7,674,850, titled HARDENABLE SELF-SUPPORTING STRUCTURES AND METHODS (Karim et al.). Other suitable hardenable compositions may include those described in U.S. Pat. No. 5,403,188 (Oxman et al.); U.S. Pat. No. 6,057,383 (Volkel et al.); and U.S. Pat. No. 6,799,969 (Sun et al.); each incorporated herein by reference.

Organogelators described in WO2008/033911, incorporated herein by reference, can be utilized in combination with the hardenable compositions and/or interior marterials in the dental implant articles described herein. These organgelator compositions can be flowable, packable, or self-supporting. The term “organogelator” means a low molecular weight compound (generally no greater than 3000 grams per mole) that forms a three-dimensional network structure when dissolved in an organic fluid, thereby immobilizing the organic fluid and forming a non-flowable thermally-reversible gel. In some embodiments the organogelator is a urea-type organogelator, a sugar-based compound, or a mixture thereof. Suitable sugar-based compounds include amino sugar organogelator, dibenzylidene sorbitol, alpha-manno(methyl 4,6,-O-benzylidene-alpha-D-mannopyranoside, or a mixture thereof.

In some embodiments, the hardenable self-supporting compositions have rheological properties similar to waxes below the waxes' melting points in that they can be relatively easily deformed (i.e., they are malleable) and exhibit low elastic recovery. The compositions are typically not free-flowing fluids (i.e., liquids) above their softening points. That is, the compositions can display appreciable mass flow under moderate (e.g., hand) pressure, but not liquid flow above their softening points.

Typically, elastic and viscous dynamic moduli of the hardenable compositions vary over a wide range. Furthermore, the hardenable compositions are typically largely free from tack. Preferably, the elastic dynamic modulus (i.e., elastic modulus) G′ is at least about 100 kilopascals (kPa), more preferably, at least about 200 kPa, and most preferably, at least about 1000 kPa, at a frequency of about 0.005 Hz. Preferably, the elastic modulus G′ is no greater than about 50,000 kPa, more preferably, no greater than about 10,000 kPa, and most preferably, no greater than about 5000 kPa, at a frequency of about 0.005 Hz. Preferably, the viscous dynamic modulus (i.e., viscous modulus) G″ is at least about 50 kPa, more preferably, at least about 200 kPa, and most preferably, at least about 1000 kPa, at a frequency of about 0.005 Hz. Preferably, the viscous modulus G″ is no greater than about 50,000 kPa, more preferably, no greater than about 10,000 kPa, and most preferably, no greater than about 5000 kPa, at a frequency of about 0.005 Hz.

The desired self-supporting (i.e., free-standing) structure of the hardenable compositions can typically be maintained by creating a morphology that includes a noncovalent structure, which may be a three-dimensional network (continuous or discontinuous) structure. This can result from the use of a crystalline component in the resin system, or the use of one or more fillers, typically aided by one or more surfactants, or the use of both a crystalline component and one or more fillers optionally combined with one or more surfactants. These components are discussed in more detail below.

With the appropriate initiator system, e.g., a free radical photoinitiator, the hardenable compositions can be hardened (e.g., cured) to form the desired product. Preferably, the resultant hardened composition (i.e., the hardened structure) has a flexural strength of at least about 25 megapascals (MPa), more preferably, at least about 40 MPa, even more preferably, at least about 50 MPa, and most preferably, at least about 60 MPa.

In some embodiments, the resultant hardened composition is an enamel-like solid, preferably having a compressive strength of at least about 100 MPa and/or a diametral tensile strength of at least about 20 MPa and/or a flexural modulus of at least about 1000 MPa.

The resin system includes one or more hardenable organic resins capable of forming a hardened material having sufficient strength and hydrolytic stability to render them suitable for use in the oral environment.

As used herein, a resin includes one or more monomers, oligomers, and/or polymerizable polymers, including combinations thereof. Although, in this context oligomers and polymers are both used, the terms “polymer” and “polymeric” are used herein to refer to any materials having 2 or more repeat units, thereby encompassing oligomers. Thus, unless otherwise specified, polymers include oligomers. Furthermore, the term polymer is used herein to encompass both homopolymers and copolymers, and the term copolymer is used herein to encompass materials with two or more different repeat units (e.g., copolymers, terpolymers, tetrapolymers)

A preferred organic resin is hardenable (e.g., polymerizable and/or crosslinkable), preferably by a free radical mechanism, and includes monomers, oligomers, and/or polymers. The resin system includes a reactive component (i.e., a component capable of polymerizing and/or crosslinking), which may or may not be crystalline. Resin systems that include noncrystalline reactive components may optionally include a crystalline component, which may or may not be reactive.

Preferably, at least some of the resin components include ethylenic unsaturation and are capable of undergoing addition polymerization. A suitable resin preferably includes at least one ethylenically unsaturated monomer (i.e., includes at least one carbon-carbon double bond).

Examples of suitable polymerizable resin components include: mono-, di-, or poly-(meth)acrylates (including acrylates and methacrylates) such as methyl acrylate, methyl methacrylate, ethyl acrylate, isopropyl methacrylate, n-hexyl acrylate, stearyl acrylate, allyl acrylate, glycerol mono- and diacrylate, glycerol triacrylate, ethyleneglycol diacrylate, diethyleneglycol diacrylate, triethyleneglycol dimethacrylate, 1,3-propanediol diacrylate, 1,3-propanediol dimethacrylate, trimethylolpropane triacrylate, 1,2,4-butanetriol trimethacrylate, 1,4-cyclohexanediol diacrylate, pentaerythritol triacrylate, pentaerythritol tetraacrylate, pentaerythritol tetramethacrylate, sorbitol hexacrylate, bis(1-(2-acryloxy))-p-ethoxyphen-yldimethylmethane, bis(1-(3-acryloxy-2-hydroxy))-p-propoxyphenyldimethylme-thane, tris(hydroxyethylisocyanurate) trimethacrylate, 2-hydroxyethyl methacrylate, 2-hydroxypropyl methacrylate, tetrahydrofurfuryl methacrylate, ethylene glycol dimetliacrylate, triethylene glycol dimethacrylate, bisGMA, ethoxylated bisphenolA diacrylate, ethoxylated bisphenolA dimethacrylate, biphenyl monomers such as described in Provisional Patent Application No. 61/094211, filed Sep. 4, 2008 and Provisional Patent Application No. 61/107400, filed Oct. 22, 2008 polyethylene glycol dimethacrylate, the bis-acrylates and bis-methacrylates of polyethylene glycols of molecular weight 200-500, copolymerizable mixtures of acrylated monomers such as those of U.S. Pat. No. 4,652,274 (Boettcher et al.), and acrylated oligomers such as those of U.S. Pat. No. 4,642,126 (Zador); unsaturated amides such as (meth)acrylamides (i.e., acrylamides and methacrylamides), methylene bis-acrylamide, methylene bis-methacrylamide, 1,6-hexamethylene bis-acrylamide, diethylene triamine tris-acrylamide, and beta-methacrylamidoethyl methacrylate, diacetone acrylamide, and diacetone methacrylamide; urethane (meth)acrylates; and vinyl compounds such as styrene, diallyl phthalate, divinyl succinate, divinyl adipate, and divinylphthalate. Mixtures of two or more such materials can be used if desired in the resin system.

Preferably, the total amount of the resin system is at least about 10 wt-%, more preferably, at least about 13 wt-%, and most preferably, at least about 15 wt-%, based on the total weight of the composition. Preferably, the total amount of the resin system is no greater than about 60 wt-%, more preferably, no greater than about 50 wt-%, and most preferably, no greater than about 40 wt-%, based on the total weight of the composition.

The above-listed components are typically noncrystalline (i.e., amorphous).

In some embodiments, the resin system can also include a crystalline component to impart the noncovalent three-dimensional structure for maintaining the initial preformed shape such as described in U.S. Pat. No. 7,674,850; incorporated herein by reference. This crystalline component may or may not have a reactive group capable of polymerizing (also including crosslinking) Preferably, the crystalline component is polymerizable. Preferably, the crystalline component is polymeric (including oligomeric). More preferably, the crystalline component is a polymerizable polymeric material.

By “crystalline” it is meant that the material displays a crystalline melting point at 20° C. or above when measured in the composition by differential scanning calorimetry (DSC). The peak temperature of the observed endotherm is taken as the crystalline melting point. The crystalline phase includes multiple lattices in which the material assumes a conformation in which there is a highly ordered registry in adjacent chemical moieties of which the material is constructed. The packing arrangement (short order orientation) within the lattice is highly regular in both its chemical and geometric aspects.

The crystalline resin component includes at least one material that crystallizes, preferably above room temperature (i.e., 20° C. to 25° C.). Such crystallinity, that may be provided by the aggregation of crystallizable moieties present in the component (e.g., when the component is a polymer, in the backbone (i.e., main chain) or pendant substituents (i.e., side chains) of the component), can be determined by well known crystallographic, calorimetric, or dynamic/mechanical methods. This component imparts to the resin system at least one melting temperature (Tₘ) as measured experimentally (for example by DSC) of greater than about 20° C. Preferably, this component imparts a T. sub. m to the resin system of about 30° C-100° C. If more than one crystalline material is used in the crystalline component, more than one distinct melting point may be seen.

Examples of suitable crystalline materials having crystallizable main chain or backbone segments include, but are not limited to, polyesters (including polycaprolactones), polyethers, polythioethers, polyarylalkylenes, polysilanes, polyamides, polyolefins (preferably, formed from lower, e.g., C₂-C₃, olefins), and polyurethanes.

Preferred crystalline materials are saturated, linear, aliphatic polyester polyols (particularly diols) containing primary hydroxyl end groups. Examples of commercially available materials useful as the crystalline resin component include some resins available under the trade designation LEXOREZ from Inolex Chemical Co., Philadelphia, Pa. Examples of other polyester polyols are those available under the trade designation RUCOFLEX from Ruco Polymer Corp., Hicksville, N.Y. Examples of polycaprolactones include those available under the trade designations TONE 0230, TONE 0240, and TONE 0260 from Dow Chemical Co., Midland, Mich. Especially preferred materials are saturated, linear, aliphatic polyester polyols that are modified (e.g., through primary hydroxyl end groups) to introduce polymerizable, unsaturated functional groups, e.g., polycaprolactone diol reacted with 2-isocyanatoethyl methacrylate, methacryloyl chloride, or methacrylic anhydride.

Examples of suitable crystalline polymeric materials having crystallizable pendant moieties (i.e., side chains) include, but are not limited to polymeric materials having the following general formula:

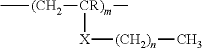

wherein R is hydrogen or a (C₁-C₄)alkyl group, X is —CH₂—, —C(O)O—, —O—C(O)—, —C(O)—NH—, —HN—C(O)—, —O—, —NH—, —O—C(O)—NH—, —HN—C(O)—0—, —HN—C(O)—NH—, or —Si(CH₃)₂—, m is the number of repeating units in the polymer, and n is great enough to provide sufficient side chain length and conformation to form polymers containing crystalline domains or regions. Preferably, m is at least 2, and more preferably, 2 to 100, and preferably, n is at least 10. The crystalline polymeric materials may be prepared by the polymerization of monomers containing the pendant (side chain) crystallizable moieties or by the introduction of pendant crystallizable moieties by chemical modification of a polyacrylate, polymethacrylate, polyacrylamide, polymethacrylamide, polyvinyl ester, or poly-alpha-olefin polymers or copolymers. The preparation and morphology/conformational properties that determine the crystalline character of such side chain crystallizable or “comb-like” polymers are reviewed by Plate and Shibaev, “Comb-Like Polymers. Structure and Properties,” Journal of Polymer Science, Macromolecular Reviews, 8, 117-253 (1974).

Another crystalline component includes compounds of the formula:

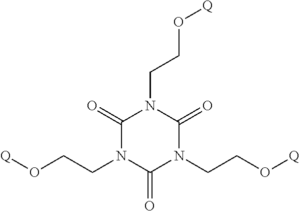

wherein each Q independently includes polyester segments, polyamide segments, polyurethane segments, polyether segments, or combinations thereof. Preferably, each Q independently includes poly(caprolactone) segments. More preferably, such crystalline compounds include polymerizable groups, such as epoxy, acid, alcohol, and ethylenically unsaturated reactive sites. Particularly preferred such materials include unsaturated polymerizable groups, such as methacrylic, acrylic, vinyl, and styryl groups.

Fillers for use in the filler system may be selected from a wide variety of conventional fillers for incorporation into resin systems. Preferably, the filler system includes one or more conventional materials suitable for incorporation in compositions used for medical applications, for example, fillers currently used in dental restoration compositions. Thus, the filler systems used in the compositions are incorporated into the resin systems, and particularly mixed with the crystalline component of the resin system.

Fillers may be either particulate or fibrous in nature. Particulate fillers may generally be defined as having a length to width ratio, or aspect ratio, of 20:1 or less, and more commonly 10:1 or less. Fibers can be defined as having aspect ratios greater than 20:1, or more commonly greater than 100:1. The shape of the particles can vary, ranging from spherical to ellipsoidal, or more planar such as flakes or discs. The macroscopic properties can be highly dependent on the shape of the filler particles, in particular the uniformity of the shape.

Preferred particulate filler is finely divided and has an average particle size (preferably, diameter) of less than about 10 micrometers (i.e., microns). Preferred micron-size particulate filler has an average particle size of at least about 0.2 microns up to 1 micrometers. Nanoscopic particles have an average primary particle size of less than 200 nm (0.2 microns). The filler can have a unimodal or polymodal (e.g., bimodal) particle size distribution.

Micron-size particles are very effective for improving post-cure wear properties. In contrast, nanoscopic fillers are commonly used as viscosity and thixotropy modifiers. Due to their small size, high surface area, and associated hydrogen bonding, these materials are known to assemble into aggregated networks. Materials of this type (“nanoscopic” materials) have average primary particle sizes (i.e., the largest dimension, e.g., diameter, of unaggregated material) of no greater than about 1000 nanometers (nm). Preferably, the nanoscopic particulate material has an average primary particle size of at least about 2 nanometers (nm), and preferably at least about 7 nm. Preferably, the nanoscopic particulate material has an average primary particle size of no greater than about 50 nm, and more preferably no greater than about 20 nm in size. The average surface area of such a filler is preferably at least about 20 square meters per gram (m²/g), more preferably, at least about 50 m²/g, and most preferably, at least about 100 m²/g.

The filler can be an inorganic material. It can also be a crosslinked organic material that is insoluble in the polymerizable resin, and is optionally filled with inorganic filler. The filler is preferably generally non-toxic and suitable for use in the mouth. The filler can be radiopaque, radiolucent, or nonradiopaque. Fillers as used in dental applications are typically ceramic in nature.

Examples of suitable inorganic fillers are naturally occurring or synthetic materials such as quartz, nitrides (e.g., silicon nitride), glasses derived from, for example Ce, Sb, Sn, Zr, Sr, Ba, or Al, colloidal silica, feldspar, borosilicate glass, kaolin, talc, titania, and zinc glass, zirconia-silica fillers; and low Mohs hardness fillers such as those described in U.S. Pat. No. 4,695,251 (Randklev).

Examples of suitable organic filler particles include filled or unfilled pulverized polycarbonates, polyepoxides, and the like. Preferred filler particles are quartz, submicron silica, and non-vitreous microparticles of the type described in U.S. Pat. No. 4,503,169 (Randklev). Mixtures of these fillers can also be used, as well as combination fillers made from organic and inorganic materials.

Optionally, the surface of the filler particles may be treated with a surface treatment, such as a silane-coupling agent, in order to enhance the bond between the filler and the resin system. The coupling agent may be functionalized with reactive curing groups, such as acrylates, methacrylates, and the like.

The filler particles used to impart a noncovalent structure can be composed of silica, alumina, zirconia, titania, or mixtures of these materials with each other or with carbon. In their synthesized state, these materials are commonly hydrophilic, due to the presence of surface hydroxyl groups. However, the materials may also be modified by treatment with appropriate agents, such as alkyl silanes, in order to modify this character. For example, the surface of a filler particle may be rendered neutral, hydrophobic, or reactive, depending on the desired properties. Fumed silica is a preferred compound for imparting self-supporting character, due to its low cost, commercial availability, and wide range of available surface character.

Preferably, the total amount of filler system is greater than 50 wt-%, more preferably, greater than 60 wt-%, and most preferably, greater than 70 wt-%, based on the total weight of the composition. If the filler system includes fibers, the fibers are present in an amount of less than 20 wt-%, based on the total weight of the composition. Preferably, the total amount of filler system is no more than about 95 wt-%, and more preferably, no more than about 80 wt-%, based on the total weight of the composition.

The compositions also contain an initiator system, i.e., one initiator or a mixture of two or more initiators, which are suitable for hardening (e.g., polymerizing and/or crosslinking) of the resin system. Various suitable initiator systems are known in the art, such as described in U.S. Pat. No. 7,674,850.

The initiators are preferably free radical initiators, which may be activated in a variety of ways, e.g., heat and/or radiation. Thus, for example, the initiator system can be a thermal initiator system (e.g., azo compounds and peroxides), or a photoinitiator system. Preferably, the initiator system includes one or more photoinitiators. More preferably, the initiator system includes at least one photoinitiator active in the spectral region of about 300 nanometers (nm) to about 1200 nm and capable of promoting free radical polymerization and/or crosslinking of ethylenically unsaturated moieties upon exposure to light of suitable wavelength and intensity. A wide variety of such photoinitiators can be used. The photoinitiator preferably is soluble in the resin system. Preferably, they are sufficiently shelf stable and free of undesirable coloration to permit storage and use under typical dental operatory and laboratory conditions. Visible light photoinitiators are preferred.

Preferred visible light-induced initiators include camphorquinone combined with a suitable hydrogen donor (e.g., an amine such as those described above for the first initiator system), and optionally a diaryliodonium simple or metal complex salt, chromophore-substituted halomethyl-s-triazine, or halomethyl oxadiazole. Particularly preferred visible light-induced photoinitiators include combinations of an alpha-diketone, e.g., camphorquinone with additional hydrogen donors, and optionally a diaryliodonium salt, e.g., diphenyliodonium chloride, bromide, iodide or hexafluorophosphate.

Preferred ultraviolet light-induced polymerization initiators include ketones, such as benzyl and benzoin, acyloins, and acyloin ethers. Preferred ultraviolet light-induced polymerization initiators include 2,2-dimethoxy-2-phenylacetophenone available under the trade designation IRGACURE 651 and benzoin methyl ether (2-methoxy-2-phenylacet-ophenone), both from Ciba Speciality Chemicals Corp., Tarrytown, N.Y.

The initiator system is present in an amount sufficient to provide the desired rate of hardening (e.g., polymerizing and/or crosslinking) For a photoinitiator, this amount will be dependent in part on the light source, the thickness of the layer to be exposed to radiant energy, and the extinction coefficient of the photoinitiator. Preferably, the initiator system is present in a total amount of at least about 0.01 wt-%, more preferably, at least about 0.03 wt-%, and most preferably, at least about 0.05 wt-%, based on the weight of the composition. Preferably, the initiator system is present in a total amount of no more than about 10 wt-%, more preferably, no more than about 5 wt-%, and most preferably, no more than about 2.5 wt-%, based on the weight of the composition.

The compositions may contain a surfactant system, i.e., one surfactant or a mixture of two or more surfactants. These surfactants, when used in small amounts may interact with other components of the composition, such as an inorganic filler material, to enhance the formation of a noncovalent three-dimensional structure. Such surfactants can be nonionic, anionic, or cationic, as described in U.S. Pat. No. 7,674,850. The surfactant(s) can be copolymerizable with the resin system or non-copolymerizable. A consideration in the choice of a surfactant that can be used is the degree to which the ingredients of the system are able to participate in hydrogen bonding.

Preferably, the total amount of surfactant system is at least about 0.05 wt-%, more preferably, at least about 0.1 wt-%, and most preferably, at least about 0.2 wt-%, based on the total weight of the composition. Preferably, the total amount of surfactant system is no more than about 5.0 wt-%, more preferably, no more than about 2.5 wt-%, and most preferably, no more than about 1.5 wt-%, based on the total weight of the composition.

The composition may additionally include optional agents such as colorants (e.g., pigments conventionally used for shade adjustment), flavorants, stabilizers (such as BHT), viscosity modifiers, and the like. Such agents may optionally include reactive functionality so that they will be copolymerized with the resin.

The composition can be shaped (to form a first shape) in a variety of ways including, for example, extruding, injection molding, compression molding, thermoforming, vacuum forming, and pressing. Typically, a semi-finished shape is formed using a mold with a positive and negative impression.

In some embodiments, the (e.g. preassembled) dental implant article consists solely of the dental implant abutment integrated with (e.g. embedded within) the (e.g. self-supporting) sufficiently malleable material as described herein. In other embodiments, only the external portion (e.g. the contacts the gingival tissue or internal tissue beneath the gingival tissue) that is intended to be customized in shape for tissue management comprises the (e.g. self-supporting) sufficiently malleable material as described herein. For example, the implant abutment may comprise a coating as previously described. As yet another example, the dental implant article may comprise a different interior material such as described in WO 2008/033893; incorporated herein by reference. In one embodiment, the dental implant articles comprise an external layer formed of a self-supporting hardenable preformed material, the external layer having a dental implant article shape defined by an external layer surface, the external layer defining an interior volume; and an interior material disposed within the interior volume, wherein the interior material is different than the external hardenable preformed material and the interior material has a yield stress value of 100 dyn/cm² or greater. Such preformed multilayer dental implant articles may have two or more layers of material to allow for accurate fit. Further, multilayer dental articles can provide better esthetics, particularly for embodiments wherein the dental implant article comprises tooth-shaped supragingival exterior surfaces e.g., by having a multi-chromatic appearance. Additionally such multilayer dental implant articles can provide a better overall balance of mechanical properties, as well as improved customization, including a more accurate fit to dental preparations.

Generally, a preformed article of appropriate size and shape (the first shape) is selected and custom shaped at a temperature of about 15° C. to 38° C. (preferably, about 20° C. to 38° C., which encompasses typical room temperatures and body temperatures, and more preferably, at room temperature). This shaping can be done by a variety of methods including applying pressure with fingers or an instrument of choice (e.g., hand operation of dental composite instrument), trimming, cutting, sculpting, grinding, etc. Once the desired custom shape has been achieved, the article is hardened (e.g., cured) by exposing it to heat/radiation to cause activation of the initiator system. This can be done either in a single step, or in multiple steps with successive steps of custom shaping being done in-between. One or more of these steps can be carried out in an oxygen-free inert atmosphere or in vacuum. After the final shaping and hardening steps, the hardened article can be further modified in shape by grinding, trimming, etc., if desired. Once the final custom shape of the article has been obtained, it can be polished, painted, or otherwise surface treated, if required for the intended application. Preferably, the final custom shaped articles (comprising tooth-shaped supragingival exterior surfaces) prepared from the compositions do not need an additional veneering material (e.g., a second material that provides a desired appearance or property). For embodiments wherein the dental implant article is a healing cap or other intermediate structure, a second object, such as a crown may be attached to the custom shaped cured article adhesively, mechanically, or by combination of both.

For the preparation of a dental implant article, an appropriate shape and size of a preformed dental implant article is selected and seated on the (e.g. temporary) implant anchor to determine the extent of trimming and shaping required, optionally making marks on the cap. The preformed dental implant article may be removed from the mouth, the required shape and size adjustments are made by cutting, trimming, shaping, etc., and then re-seated on the implant anchor where additional shape adjustments are made to provide optimum custom fit, including at least gingival fit. When the dental implant article comprises a supragingival tooth-shaped structure the adjustments typically also include lateral and occlusal fit. The preformed and reshaped dental implant article can then be hardened, typically by exposing it to a dental curing light for a few seconds, if desired, while in the mouth, and then removing it carefully from the mouth and exposing it for final cure to a curing light in a cure chamber, optionally in combination with heat. Additional adjustments can be made by grinding, trimming, etc., if required, and the finished dental implant article is polished and cleaned.

The hardenable (e.g. self-supporting structures) dental implant article can be prepackaged either individually, in multiple units, or as an ensemble. Such packaging material should protect these products from conditions that would activate the initiator system and thus cause premature hardening, e.g., such as could result from exposure to light in the case of a photoinitiator.

Various methods of manufacturing hardenable dental articles, packaged hardenable dental articles, and methods of packaging hardenable dental articles are known, such as described in U.S. Pat. No. 7,811,486; incorporated herein by reference. Such method can be adapted to include embedding a dental implant abutment during manufacture of the dental implant article. For example, in one embodiment, the method comprises providing a preformed dental implant abutment having a implant anchor-receiving end and an opposing end and providing the opposing end of the dental implant abutment within a mold cavity. The mold cavity is suitably shaped for making a dental article, such as a healing cap optionally comprising tooth-shaped supragingival exterior surfaces. Hence the shape of the mold cavity of the mold body provides a net-shape or near-net shape to the dental implant article.

The mold body may be formed in any suitable material or combination of materials, e.g., metals, polymeric materials, etc. that provide sufficient structural integrity to withstand the forming process as described herein. In some instances, the mold body may be formed in separable sections to facilitate removal of a hardenable dental implant article formed therein. Also, the mold body may be made of or coated with a material adapted to aid release of a hardenable dental implant article from the interior surfaces of the mold cavity. For example, the interior surfaces of the mold cavity may be coated with, e.g., fluorinated polymers (e.g., PTFE, etc.), boron carbide, chrome, thin dense chrome, chromium nitride, electroless nickel infused with fluorinated polymers, modified tungsten disulfide (e.g., DICRONITE), etc.

The method further comprises filling the mold cavity with a sufficiently malleable hardenable material. The mold cavity may be temperature controlled to assist in the molding process by, e.g., heating and/or cooling the temperature of the interior surfaces of the mold cavity. In yet other variations, the mold cavity may be vented or evacuated during the molding process to enhance molding. Ultrasonic or other vibrational energy may also be used to enhance filling of the mold cavity and/or assist with release the article from the mold cavity. Hence, the sufficiently malleable material is typically subjected to an elevated temperature and/or pressure and/or vibrational energy such that the material is sufficiently flowable to take the shape of the mold cavity. Since the sufficiently malleable material comprises curable components such as those which can be photocured, the sufficiently malleable material can be subsequently hardened by curing after customizing of the shape (e.g. that contacts the healing tissue).

The dental implant abutment can be introduced either prior to or after filling or partial filling of the mold cavity (e.g. but prior to cooling).

In various embodiments, the manufacturing may involve molding a hardenable dental material in a mold cavity that may be lined with a mold liner. The use of a mold liner during manufacturing of hardenable dental implant articles from hardenable dental materials may provide a number of potential advantages such as assisting with release of the hardenable dental implant article from the mold cavity; protecting the hardenable dental implant article from contamination, enhancing the finish of the hardenable dental implant article by providing a smooth finish on the article during the forming process (if the liner itself is smooth), and enhancing the finish of the dental implant article after hardening (if the smooth inside surface of the mold liner is retained in intimate contact with the outer surfaces of the hardenable dental implant article during hardening).

If a mold liner is used in connection with the manufacturing of a hardenable dental implant article, it may be preferred that the mold liner be in intimate contact with the outer surfaces of the hardenable dental implant article after release of the hardenable dental article from the mold cavity. Alternatively, the hardenable dental article may release from the mold liner after or during its removal from the mold cavity.

One method of manufacturing comprises providing a mold cavity in a shape of a hardenable dental article, wherein the mold cavity comprises an opening; forcing a hardenable dental material into the mold cavity through the opening; providing an outer liner between the hardenable dental material and the mold cavity; and removing the hardenable dental material and the outer liner from the mold cavity.

In one embodiment, the method comprises providing the outer liner between the hardenable dental material and the mold cavity comprises deforming the outer liner to form a pocket therein by forcing the hardenable dental material into contact with the outer liner, wherein the hardenable dental material is located within the pocket before forcing the hardenable dental material into the mold cavity. Forcing the hardenable dental material through the opening may comprise forcing a core pin against the hardenable dental material, and a pin liner may be provided between the hardenable dental material and the core pin.

The hardenable dental material typically has the shape of the hardenable dental article. Further, the outer liner releases from the hardenable dental article after or during removal from the mold cavity. The (e.g. preassembled) hardenable dental article may comprise a mass of hardenable dental material in the shape of a hardenable dental article, wherein the hardenable dental article comprises a base and outer surfaces extending from the base; and a package cover conforming to the outer surfaces of the hardenable dental article. The package cover comprises a polymeric film plastically deformed by the mass of hardenable dental material. The package cover may include a flange extending away from the hardenable dental article in order to provide a handle for removal of the package cover.

In other embodiments, preformed pieces of sufficiently malleable material can be modified for inclusion of the dental implant abutment. The preformed pieces are suitably shaped for use as a healing cap optionally comprising tooth-shaped supragingival exterior surfaces. Such preformed pieces can be suitable shaped by use of molding (as just described without embedding the opposing end of the implant abutment). Alternatively such preformed pieces can be milled into such suitable shape.

A hole can then be formed into the shaped (e.g. self-supporting) piece of sufficiently malleable material. The opposing end of the dental implant abutment can then be provided within the hole. The method can comprise filling the remainder of the hole with a hardenable material. In some embodiments, the hardenable material may be hardened (by curing) when manufactured. In other embodiments, the hardenable material may be concurrently hardened (by curing) concurrently with hardening (by curing) of the sufficiently malleable material. Although the hardenable material may comprise the same sufficiently malleable material, the hardenable material is typically a different hardenable (e.g. composite) material. This method is particularly useful when the “different hardenable material” is a (e.g. relatively low viscosity) ceramic dental restoration material or polymer-ceramic composite dental restoration material such as Filtek Supreme Plus Flowable Restorative. Even though such dental restoration material may differ from the sufficiently malleable material, in this embodiment the material at the implant abutment interface is a dental restoration material, rather than an adhesive.

Alternatively, but less preferred, a small hole can be formed into the hardenable (e.g. self-supporting) piece of sufficiently malleable material having an appropriate depth (about equal to the height of the opposing end) and the implant abutment may simply be affixed within such small cavity with a adhesive or a (e.g. permanent) cement. Various dental adhesives and dental cements that are known to have good adhesion to dental restoration materials may be employed. One suitable dental cement is available from 3M ESPE, (St. Paul, Minn.) under the trade designation “RelyX Unicem Self Adhesive Universal Resin Cement”. However, since the dental abutment is adhered to the sufficiently malleable outside of the mouth, only the cured adhesive or cement need be biocompatible, rather than both the uncured and cured adhesive or cement as is the case when a (e.g. crown) restoration is adhesively bonded to an implant abutment. Accordingly, various non-dental adhesive or cements can also be utilized. In this embodiment, the interface between the opposing end of the implant abutment and the restoration material comprises an adhesive and/or cement.

In favored embodiments, the opposing end of the implant abutment is embedded in the surrounding sufficiently malleable material such that the interface between the implant abutment and the restoration material is free of adhesive and/or cement.

In preferred embodiments, the sufficiently malleable portion of the dental implant article described herein are self-supporting and thus the package enclosing the dental implant article(s) predominantly serves a typical “packaging function” such as protecting the dental implant article from damage or contamination. In alternative embodiments, the sufficiently malleable portion of the dental article are not self-supporting. In this embodiment, the package additionally serves the purpose of supporting the preformed shape of the sufficiently malleable portion. For example the dental implant article may be provided in a (e.g. disposable plastic) package wherein the portion of the package in contact with the sufficiently malleable portion comprises the net-shape or near-net shape of a healing cap optionally comprising tooth-shaped supragingival exterior surfaces.

### Healing Cap Formation

A wax model was formed in the shape of a healing cap for a posterior tooth, the shape being further described in PCT/US2010/022961. A silicone impression material (3M Imprint II Wash Material, Regular Viscosity, available from 3M ESPE), was used to create a two-part mold having the negative shape of the wax model. The parting line of the mold was along the widest horizontal circumference of the healing cap. Several malleable, curable crowns (Protemp Crowns, Temporization Material-Molar Upper Large, available from 3M ESPE), formed from a malleable, photocurable composite material, were heated to 60 deg. C. and combined to make a bulk paste material. About 0.74 g. of the warmed paste material was placed into the mold, which was then closed around the material and allowed to cool for 3 hrs. at 4 deg. C. After cooling, the mold was opened and the finished healing cap was removed.

### Test Method

The healing caps were pressed around the portion of an abutment intended to receive the restoration (Neoss Matrix Aesthetic Abutments, compatible with Straumann 4.8 mm implants, available from Neoss Inc., Woodland Hills, Calif.). The healing cap was then cured for 60 sec. using an Elipar S10 Curing Light (3M ESPE), while slowly rotating the healing cap to irradiate all sides. A Straumann implant analog (Straumann USA, Andover, Mass.) was attached to the base of the abutment with the corresponding screw. The abutment having the attached healing cap and implant analog was mounted in an Instron (Model 5500R, Instron Corp., Canton, Mass.). The implant analog was clamped in the stationary jaws of the Instron. To avoid the griper jaws crushing the healing cap, a custom steel plate having a circular hole slightly larger than the abutment but smaller than the healing cap was used to encircle the base of the abutment with the healing cap resting on the plate. The edges of the steel plate were gripped in the pulling jaws of the Instron and the jaws were pulled apart at a crosshead speed of 1.0 mm/min, thus applying the pulling force to the base of the healing cap.

### EXAMPLE 1

A healing cap was attached to an abutment as received with no further surface treatment, and cured. Duplicate tests were performed, and the forces required to pull the healing cap from the abutment were 2.1 kg and 2.8 kg.

### EXAMPLE 2

A healing cap was attached to an abutment as received that had been coated with Filtek Supreme Plus Flowable Restorative, A 3.5 shade, (3M ESPE), and cured. Duplicate tests were performed, and the forces required to pull the healing cap from the abutment were 8.9 kg and 15.9 kg.

### EXAMPLE 3

A healing cap was attached to an abutment that had been sandblasted at 2 bars of pressure with 50 um aluminum oxide using a Vaniman Sandstorm XL (Vaniman Co., Fallbrook, Calif.), the nozzle being positioned about ½″ from the abutment, leaving a roughened, matte surface on the metal, and cured. Duplicate tests were performed, and the forces required to pull the healing cap from the abutment were 13.5 kg and 19.1 kg.

### EXAMPLE 4

A 0.75 g piece of Filtek P60 Posterior Restorative, A3 shade (available from 3M ESPE) was placed in the mold described under Healing Cap Formation, which was then closed around the material. Both the dental material and the mold were at room temperature. The filled mold was allowed to cool for 2 hours at 4 deg. C., after which the mold was opened and healing cap was removed.

The (opposing) portion of an abutment intended to receive the restoration (Neoss Matrix Aesthetic Abutments, compatible with Straumann 4.8 mm implants, available from Neoss Inc., Woodland Hills, Calif.) was sandblasted according to Example 3. Then the healing cap was pressed around the sandblasted portion of the abutment.

1. A preassembled dental implant article comprising a preformed dental implant abutment comprising a subgingival implant anchor-receiving end and an opposing end wherein the opposing end is permanently bonded within a hardenable sufficiently malleable dental material comprising one or more monomers, oligomers, and/or polymerizable polymers and the dental abutment is a different material than the sufficiently malleable material.

2. The preassembled dental implant article of claim 1 wherein the implant abutment is a metal abutment, a ceramic abutment, a plastic abutment, a composite abutment, or a hybrid thereof

3. The preassembled dental implant article of claim 2 wherein at least the opposing end of the abutment comprises a coating.

4. The preassembled dental implant article of claim 1 wherein the opposing end comprises mechanical retention features that span at least 50% of the opposing end height.

5. The preassembled dental implant article of claim 4 wherein the mechanical retention features comprise horizontal grooves or horizontal protrusions.

6. The preassembled dental implant article of claim 1 wherein the opposing end is permanently bonded within the sufficiently malleable dental material such that the pull strength is at least 5 kg after curing.

7. The preassembled dental implant article of claim 1 wherein the sufficiently malleable dental material further comprises a bore for providing access to an internal bore of the implant abutment.

8. The preassembled dental implant article of claim 1 wherein the sufficiently malleable dental material further comprises a partial bore or visible marking for indicating the location of an internal bore of the implant abutment.

9. The preassembled dental implant article of claim 1 wherein the sufficiently malleable dental material has sufficient malleability to be formed in shape at a temperature of about 15° C. to 38° C.

10. The preassembled dental implant article of claim 1 wherein sufficiently malleable dental material comprises greater than 50 wt-% filler.

11. The preassembled dental implant article of claim 1 wherein the sufficiently malleable dental material comprises has a flexural strength of at least about 25 MPa after curing.

12. The preassembled dental implant article of claim 1 wherein the sufficiently malleable dental material has a self-supporting shape.

13. The preassembled dental implant article of claim 1 wherein the sufficiently malleable dental material lacks a self-supporting shape.

14. The preassembled dental implant article of claim 13 wherein the sufficiently malleable dental material has a shape supported by a surrounding package.

15. The preassembled dental implant article of claim 14 wherein a removable liner is disposed between the sufficiently malleable material and the surrounding package.

16. The preassembled dental implant article of claim 1 wherein the dental implant article comprises a convex gingival exterior surface.

17. The preassembled dental implant article of claim 1 wherein the dental implant article comprises a convex subgingival exterior surface.

18. The preassembled dental implant article of claim 1 wherein the dental implant article lacks tooth-shaped supragingival exterior surfaces.

19. The preassembled dental implant article of claim 1 wherein the dental implant article comprises tooth-shaped supragingival exterior surfaces.

20. The preassembled dental implant article of claim 1 wherein the opposing end of the preformed dental abutment is permanently bonded within the sufficiently malleable material at an interface that is free of cement and adhesive.

21. The preassembled dental implant article of claim 1 wherein the preassembled dental implant article is provided in a package.

22-24. (canceled)

25. A method of making a dental implant article comprising:
providing a preformed dental implant abutment having an implant anchor-receiving end and an opposing end;
providing the opposing end of the dental implant abutment within a mold cavity, wherein the mold cavity is suitably shaped for use as a healing cap optionally comprising tooth-shaped supragingival exterior surfaces;
filling the mold cavity with a hardenable sufficiently malleable material comprising one or more monomers, oligomers, and/or polymerizable polymers.

26. The method of claim 25 further comprising a liner disposed between the mold cavity and the sufficiently malleable material.

27. A method of making a dental implant article comprising:
providing a preformed dental implant abutment having an implant anchor-receiving end and an opposing end;
forming a hole in a piece of hardenable sufficiently malleable material comprising one or more monomers, oligomers, and/or polymerizable polymers, the piece suitably shaped for use as a healing cap optionally comprising tooth-shaped supragingival exterior surfaces;
providing the opposing end of the dental implant abutment within the hole; and filling the remainder of the hole with a hardenable material.

28. The method of claim 27 further comprising providing a bore suitable for providing access to an internal bore of the implant abutment.

29-31. (canceled)
